(19) United States
(12) Patent Application Publication
(10) Pub. No.: US 2003/0036415 A1
(43) Pub. Date: Feb. 20, 2003

(54) Mobile apparatus and power supply system therefor

(76) Inventors: Toshiya Shimodaira, Toyoake-city (JP); Shinro Torii, Chiryu-city (JP)

Correspondence Address: HARNESS, DICKEY & PIERCE, P.L.C., P.O. BOX 828, BLOOMFIELD HILLS, MI, 48303, US

(21) Appl. No.: 10/216,106

(22) Filed: Aug. 8, 2002

(30) Foreign Application Priority Data
Aug. 10, 2001 (JP) 2001-244216

(51) Int. Cl. H04B 1/16; H04M 1/00; H04B 1/38

(52) U.S. Cl. 455/572; 455/570; 455/343

(57) ABSTRACT

When a microcomputer of an electronic control unit determines that an ACC switch undergoes OFF-ON shift, the mobile telephone is controlled to shift the power supply state from the power supply OFF to the power supply ON. If the time passing after the ACC switch undergoes the OFF-ON shift is within a certain period of time, the mobile telephone is controlled to maintain the power supply OFF state. Therefore, even when the ACC switch is turned on and off repeatedly, it is prevented that the power supply of the mobile telephone is turned on and off repeatedly in connection with the repetition of the ON/OFF of the ACC switch.

### CROSS REFERENCE TO RELATED APPLICATION

This application is based on and incorporates herein by reference Japanese Patent Application No. 2001-244216 filed on Aug. 10, 2002.

### FIELD OF THE INVENTION

The present invention relates to a power supply system for power supply controlling a mobile apparatus.

### BACKGROUND OF THE INVENTION

A car-mounted telephone system includes a mobile telephone, a car-mounted electronic control unit, a microphone and a speaker. The car-mounted electronic control unit electronically controls the mobile telephone to allow a driver to use the microphone and the speaker for hands-free speech.

In this case, when an ACC switch (accessory device switch) is turned on by an ignition key, or when an ignition switch is turned on, a microcomputer of the electronic control unit turns on the power supply for the mobile telephone. On the other hand, when the ACC switch is turned off by the ignition key, the microcomputer turns off the power supply for the mobile telephone.

In this way, the electronic control unit associates the power supply state of the mobile telephone with the switch state of the ACC switch. Therefore, the driver does not have to realize the power supply state of the mobile telephone so that the hands-free speech can be performed without difficulty.

However, when the ACC switch is turned on and off by the ignition key repeatedly, the mobile telephone repeats turning on and off the power supply. Thus, repeating to turn the ACC switch on and off adversely affects on the mobile phone.

### SUMMARY OF THE INVENTION

Accordingly, it is an object of the present invention to provide a power supply system, which can prevent the adverse effect on a mobile telephone.

According to the present invention, a power supply system for a mobile apparatus generates a power-on signal to start an electric power supply a mobile apparatus from a power OFF condition when a user-operable vehicle switch is turned on. The system further generates a power-off signal to stop the electric power supply to the mobile phone from a power ON condition when the vehicle switch is turned off. A control circuit maintains the power OFF condition and the power ON condition for a predetermined period after the power-on signal and the power-off signal are generated, respectively, irrespective of changes of ON/OFF conditions of the vehicle. Thus, the mobile apparatus is allowed to continues its present operation even if the vehicle switch is turned on and off repeatedly. This is particularly advantageous for a mobile phone which is operated in hands-free mode.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electric circuit configuration for a car-mounted mobile telephone system according to a first embodiment of the present invention;

FIG. 2 is a flowchart showing an operation of a microcomputer of an electronic control unit shown in FIG. 1;

FIG. 3 is a flowchart showing an operation of a microcomputer of a mobile telephone shown in FIG. 2;

FIG. 4 is a timing diagram showing an operation of the first embodiment;

FIG. 5 is a block diagram showing an electric circuit configuration for a car-mounted telephone system according to a second embodiment of the present invention;

FIG. 6 is a flowchart showing an operation of a microcomputer of a mobile telephone shown in FIG. 5; and

FIG. 7 is a timing diagram showing an operation of the second embodiment.

### DETAILED DESCRIPTION OF THE PREFERRED EMBODIMENTS

(First Embodiment)

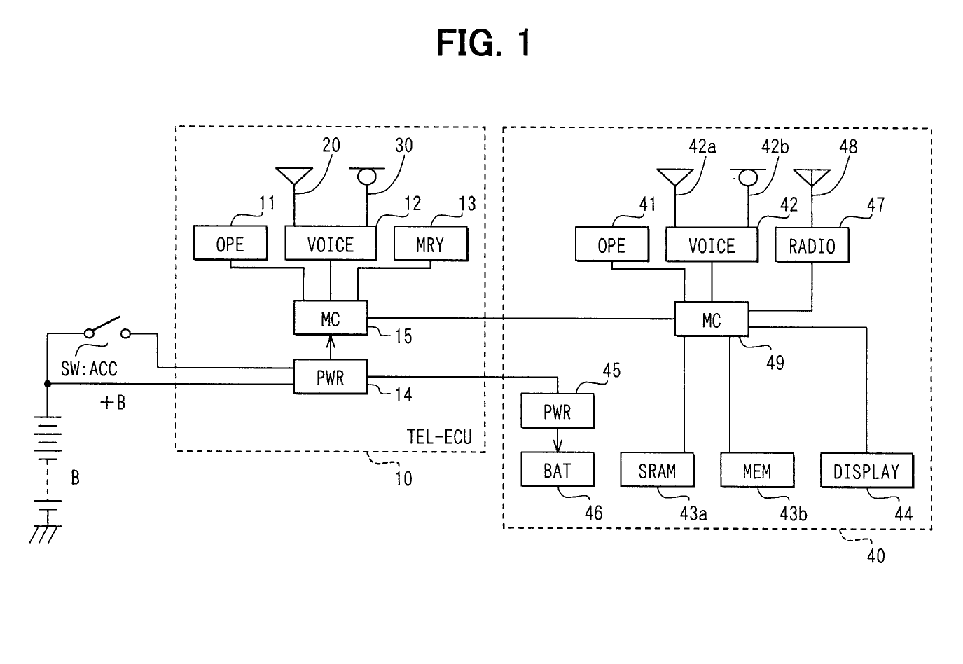

Referring first to FIG. 1, a car-mounted telephone system includes an electronic control unit (TEL-ECU) 10 and a mobile telephone 40. The electronic control unit 10 has a speaker 20, a microphone 30 and a mobile telephone 40. The electronic control unit 10 has an operating unit 11, a voice processing circuit 12, a nonvolatile memory 13, a power supply circuit 14 and a microcomputer 15. The operating unit 11 includes different kinds of keys such as a speech start key. The operating unit 11 is located on the external wall of a supporting member for a steering in a vehicle, for example.

The voice processing circuit 12 is controlled by the microcomputer 15 to digital/analog convert incoming signals and output receiving speech signals. The voice processing circuit 12 is controlled by the microcomputer 15 to analog/digital convert transmitting speech signals and output outgoing signals. The nonvolatile memory 13 stores computer programs for the microcomputer 15.

The power supply circuit 14 is connected to a positive terminal of a battery B through an ACC switch SW. Furthermore, the power supply circuit 14 is connected to a microcomputer 49 of the mobile telephone 40 through an electric wire.

Therefore, the power supply circuit 14 steps down the positive voltage of the battery B and outputs a high level signal to the microcomputer 15 when the ACC switch SW is ON (closed state). On the other hand, the power supply circuit 14 outputs a low level signal to the microcomputer 15 when the ACC switch SW is OFF (open state). The ACC switch SW is opened or closed (ON/OFF) through an operation performed by a car driver on a key cylinder by using the ignition key.

The power supply circuit 14 is directly connected to the positive terminal of the battery B. Furthermore, the power supply circuit 14 is connected to the power supply circuit 45 of the mobile telephone 40 through an electric wire (charging line). Thus, the power supply circuit 14 receives the positive voltage from the positive terminal of the battery B. The power supply circuit 14 steps down the positive voltage (+B) and outputs a certain voltage (for example, 12 V) to a power supply circuit 45. The microcomputer 15 performs different kinds of processing such as hands-free speech processing and power supply control processing.

The speaker 20 converts an incoming signal from the voice processing circuit 12 to a receiving speech signal and outputs receiving voice. In addition, the microphone 30 receives transmitting voice and outputs a transmitting speech signal to the voice processing circuit 12. The speaker 20 is integrated with the operating unit 11 together with the microphone 30.

The mobile telephone 40 includes an operating unit 41, a voice processing circuit 42, a speaker 42a, a microphone 42b, an SRAM 43a, a nonvolatile memory 43b, a display 44, a power supply circuit 45, a secondary battery 46, a radio unit 47, an antenna 48, and a microcomputer 49. Furthermore, the operating unit 41 includes different kinds of keys such as a speech start key, a power supply key and character/number keys.

The voice processing circuit 42 is controlled by the microcomputer 49 to digital/analog convert incoming signals from the radio unit 47 and output receiving speech signals. On the other hand, the voice processing circuit 49 is controlled by the microcomputer 49 to analog/digital convert transmitting speech signals from the microphone 42b and output outgoing signals.

The speaker 42a receives incoming signals from the voice processing circuit 42 and outputs receiving speech signals. The microphone 42b receives transmitting voice and outputs transmitting signal to the voice processing circuit 42. The nonvolatile memory 43b stores computer programs and different kinds of data of the microcomputer 49 when power supply is terminated. The SRAM 43a stores different kinds of data while receiving certain power supply. The display 44 is controlled by the microcomputer 49 to display different kinds of images.

The power supply circuit 45 receives a certain voltage (for example, 12 V) from the power supply circuit 14 of the electronic control unit 10 through the electric wire (charging line). The power supply circuit 45 steps down the certain voltage and supplies stepped-down voltage to the secondary battery 46. Thus, the secondary battery 46 is charged from the power supply circuit 45. The secondary battery 46 supplies power to the voice processing circuit 42, the nonvolatile memory 43b, the SRAM 43a, the radio unit 47, the microcomputer 49 and so on.

The radio unit 47 is controlled by the microcomputer 49 to receive outgoing signals from either one of the voice processing circuit 42 and the microcomputer 15. Then, the radio unit 47 modulates the outgoing signal and outputs outgoing communication signals.

The radio unit 47 is controlled by the microcomputer 49 to demodulate incoming communication signals from the antenna 48 and outputs incoming signals to either one of the voice processing circuit 42 and the microcomputer 15. The antenna 48 sends outgoing communication signals from the radio unit 47 by radio waves. In addition, the antenna 48 receives incoming communication signals by radio waves. The microcomputer 49 performs speech processing, power supply processing and so on.

An operation according to this embodiment will be described below. First of all, when the mobile telephone 40 and the electronic control unit 10 are not connected, the mobile telephone 40 is released from the control by the electronic control unit 10.

Thus, when the microcomputer 49 of the mobile telephone 40 performs speech processing, the radio unit 47 demodulates incoming communication signals from the antenna 48 and outputs incoming signals. Then, the voice processing circuit 42 digital/analog converts the incoming signals from the radio unit 47 and outputs receiving speech signals. Then, the speaker 20 converts and outputs the receiving speech signals to the receiving voice.

Thus, the voice processing circuit 49 analog/digital converts the transmitting speech signals from the microphone 42b and outputs outgoing signals. Then, the radio unit 47 receives the outgoing signals from the voice processing circuit 42. The radio unit 47 modulates the outgoing signals and outputs the outgoing communication signals. The antenna 48 sends the outgoing communication signals by the radio waves.

In this way, when the mobile telephone 40 and the electronic control unit 10 are not connected, the mobile telephone 40 can perform speech processing by itself. However, when the mobile telephone 40 and the electronic control unit 10 are connected through an electric wire, the microcomputer 49 of the mobile telephone 40 is controlled by the electronic control unit 10.

Here, when the microcomputer 15 of the electronic control unit 10 performs hands-free speech processing, the control processing over the voice processing circuit 42 in the microcomputer 49 is inhibited. Then, the control processing is performed on the voice processing circuit 12.

Therefore, the radio unit 47 demodulates incoming communication signals from the antenna 48 and outputs incoming signals. The incoming signals are output to the voice processing circuit 12 through the microcomputer 49 and then through microcomputer 15. Thus, the voice processing circuit 12 digital/analog converts incoming signals and outputs incoming speech signals. Then, the speaker 20 converts and outputs the incoming speech signals to incoming voice.

Thus, the voice processing circuit 42 analog/digital converts the outgoing speech signals from the microphone 42b and outputs outgoing signals. The outgoing signals are output to the radio unit 47 through the microcomputer 15 and then through the microcomputer 49. Thus, the radio unit 47 modulates outgoing signals from the microcomputer 15 and outputs outgoing communication signals. Therefore, the antenna 48 sends the outgoing communication signals by radio waves.

Thus, the driver can perform hands-free communication by using the speaker 20 and the microphone 30 without holding the mobile telephone 40.

In addition, when the mobile telephone 40 and the electronic control unit 10 are not connected, and when the operating unit 41 is pressed, the microcomputer 49 turns ON the power supply. On the other hand, when the operating unit 41 is pressed again, the power supply is turned ON. In this way, the mobile telephone 40 can be turned ON/OFF independently from the electronic control unit 10.

On the other hand, when the mobile telephone 40 and the electronic control unit 10 are connected through an electric wire, and when the electronic control unit 10 (TEL-ECU) performs power supply control processing, the mobile telephone 40 is controlled by the electronic control unit 10 such that the power supply is turned on and off.

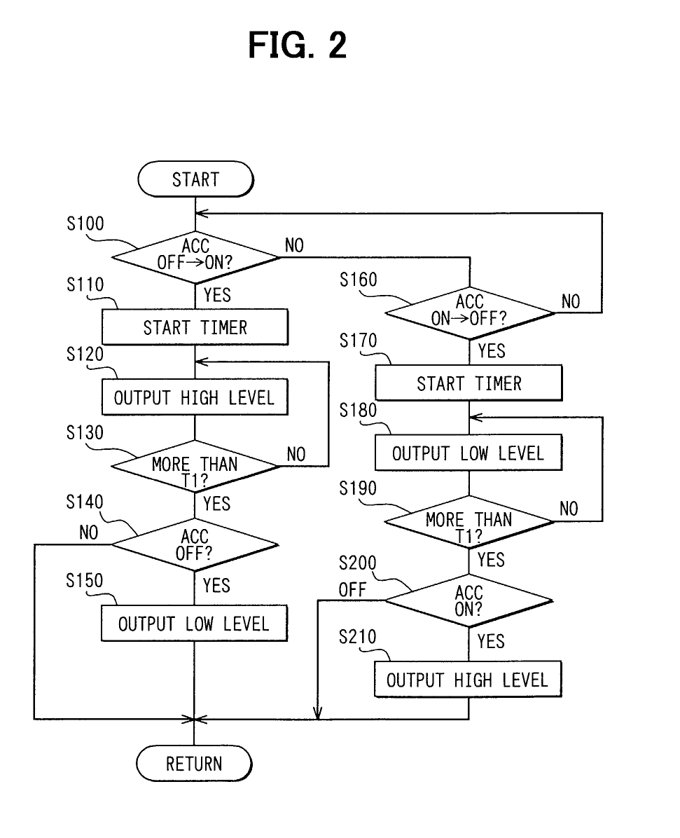

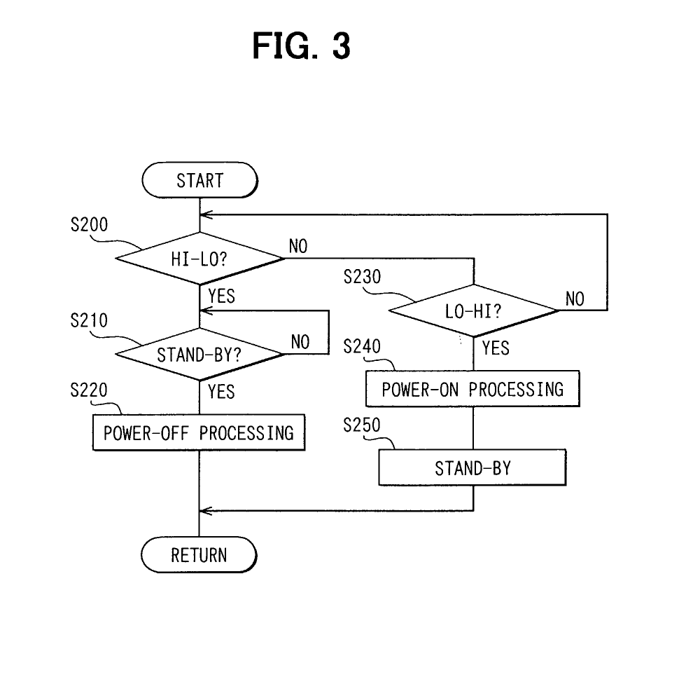

The power supply control processing by the electronic control unit 10 will be described below with reference to FIGS. 2 and 3. FIG. 2 is a flowchart showing power supply processing by the microcomputer 15 of the electronic control unit 10.

First, the microcomputer 15 starts the execution of a computer program in accordance with steps shown in the flowchart in FIG. 2. That is, at step S100, it is determined whether the ACC switch SW is shifted from the OFF state to the ON state. Here, when the output signal from the power supply circuit 14 shift from the low level to the high level, it is determined that the ACC switch SW shifts from the OFF state to the ON state (this is defined as OFF-ON shift). The processing proceeds to step S110, where the built-in timer is started to count time. Then, the power supply control signal at the high level is output to the microcomputer 49 of the mobile telephone 40 at step S120.

Next, based on the count by the built-in timer, it is determined at step S130 whether or not the time passing from the OFF-ON shift in the ACC switch SW is within a certain period of time T1. Here, when the time passing from the OFF-ON shift is within the certain period of time T1, the processing returns to step S120. On the other hand, when the time passing from the OFF-ON shift is equal to or more than the certain period of time T1 at step S130, the processing proceeds to step S140.

Here, it is determined at step A140 whether or not the ACC switch SW is in the OFF state. Then, when the output signal from the power supply circuit 14 is at the low level, it is determined that the ACC switch SW is in the OFF state. Then, the processing proceeds to step S150, where the power supply control signal is changed from the low level to the high level.

Next, when it is determined at step 100 that the ACC switch SW does not undergo the OFF-ON shift, that is, when the ACC switch SW is in one of the state where the ON state is shifted to the OFF state (this is defined as ON-OFF shift), is in the ON state or the OFF state, the processing proceeds to step S160.

Here, when the output signal from the power supply circuit 14 shifts from the high level to the low level, it is determined that the ACC switch undergoes the ON-OFF shift. Then, the processing proceeds to step S170. Then, the built-in timer starts counting, and the power supply control signal at the low level is output to the microcomputer 49 of the mobile telephone 40 at S180.

Next, based on the count by the built-in timer, it is determined at step S190 whether or not the time passing from the ON-OFF shift in the ACC switch SW is within a certain period of time T1. Here, if the time passing from the ON-OFF shift is within the certain period of time T1, the processing returns to step S180. On the other hand, if the time passing from the ON-OFF shift is equal to or more than the certain period of time T1 at step S190, the processing proceeds to step S200.

Thus, it is determined at step S200 whether or not the ACC switch SW is in the ON state. Then, when the output signal from the power supply circuit 14 is at the high level, it is determined that the ACC switch SW is in the ON state. Then, the processing proceeds to step S210, where the power supply control signal is changed from the high level to the low level.

Here, the microcomputer 49 of the mobile telephone 40 turns on and off the power supply in response to the power supply control signal from the electronic control unit 10 while the power supply processing is being executed. The power supply processing of the microcomputer 49 will be described below with reference to FIG. 3. FIG. 3 is a flowchart showing the power supply processing by the microcomputer 49 of the mobile telephone 40.

First, the microcomputer 49 starts to execute a computer program in accordance with steps in the flowchart shown in FIG. 3. That is, at step S200, it is determined whether or not the power supply control signal is shifted from the high level to the low level (this is defined as High-Low (HI-LO) shift). Then, if the power supply control signal undergoes the High-Low shift, the processing proceeds to step S210, where it is determined whether or not it is in stand-by mode. Then, if it is in stand-by mode, the power supply OFF processing is performed at step S220.

Here, before the power supply OFF processing, when a telephone number of the other party is input by pressing the operating unit 11, the telephone number is stored in the SRAM 43a through the microcomputers 15 and 49. Then, in the power supply OFF processing, the telephone number in the SPAM 43a is moved to the nonvolatile memory 43b.

Next, at the S200, when it is determined that the power supply control signal does not undergo the Hi-Lo shift, that is, when the power supply control signal is in the shift from the low level to the high level (Lo-Hi shift), in the the low level and the high level, the processing proceeds to step S230.

Here, it is determined whether or not the power supply control signal undergoes the Lo-Hi shift. If the power supply control signal undergoes the Lo-Hi shift, the processing proceeds to step S240, where the power supply is turned on and becomes in standby mode at step S250.

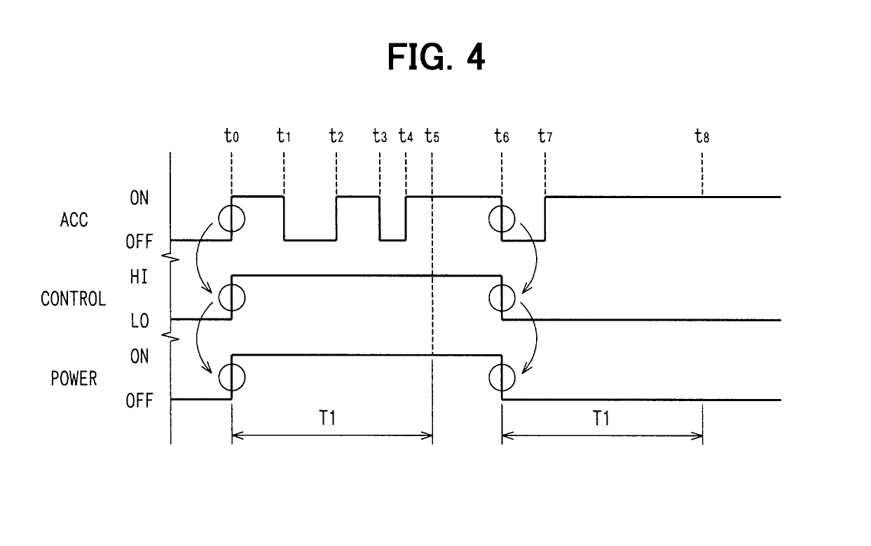

Next, a specific operation of this embodiment will be described with reference to FIG. 4. FIG. 4 is a time-chart showing power supply states of the ACC switch SW, the power supply control signal and the mobile telephone.

First, at timing t0, when the ACC switch SW is shifted from OFF to ON, the electronic control unit 10 changes the power supply control signal from the low level to the high level. Thus, the mobile telephone 40 is turned to the power supply ON state.

Here, even if the state of the ACC switch SW is repeatedly changed when a time passing from the timing t0 is within a certain period of time T1, that is, at timing t1, t2, . . . , or t5, the electronic control unit 10 maintains the power supply control signal at the high level. Thus, the mobile telephone 40 maintains the power supply ON state.

After that, at timing t6 which is after timing t0 for more than the certain period of time T1, the ACC switch SW shifts from ON to OFF. Then, the electronic control unit 10 changes the power supply control signal from the high level to the low level. Thus, the mobile telephone 40 is turned to the power supply OFF state.

Even if the ACC switch SW is shifted from OFF to ON at timing t7 after a time within the certain period of time T1 from the timing t6, the electronic control unit 10 maintains the power supply control signal at the low level. Thus, the mobile telephone 40 maintains the power supply in the OFF state.

Features of this embodiment will be described below. The microcomputer 15 of the electronic control unit 10 determines whether or not the ACC switch SW undergoes OFF-ON shift (S100). Then, if the ACC switch SW undergoes the OFF-ON shift, the power supply control signal is changed from the low level to the high level. That is, the mobile telephone 40 is controlled to change the power supply from OFF to ON (S120).

Here, the time passing after the ACC switch SW undergoes the OFF-ON shift is measured. If the measured passed time is within the certain period of time T1, the mobile telephone 40 is controlled to maintain the power supply in the OFF state (S130).

On the other hand, the microcomputer 15 determines whether or not the ACC switch SW undergoes the ON-OFF shift (S160). Then, if the ACC switch SW undergoes the ON-OFF shift, the power supply control signal is changed from the high level to the low level. That is, the mobile telephone 40 is controlled to shift the power supply state from ON to OFF (S180).

Here, the time passing after the ACC switch SW undergoes the ON-OFF shift is measured. If the measured passed time is within the certain period of time T1, the mobile telephone 40 is controlled to maintain the power supply in the ON state (S190).

In this way, when the time passing from the change in state of the ACC switch SW is within the certain period of time T1, the microcomputer 15 of the electronic control unit 10 maintains the level of the power supply control signal. Thus, when the passed time is within the certain period of time T1, the mobile telephone 40 maintains the power supply state.

Therefore, even when the ACC switch undergoes ON/OFF repeatedly, it is prevented to repeat the power supply ON/OFF of the mobile telephone 40 in connection with the ACC switch ON/OFF. As a result, the number of time of the power supply ON/OFF of the mobile telephone 40 can be reduced, which can also prevent the bad influence on the mobile telephone 40.

More specifically, when the time passing after the ON-OFF shift of the ACC switch SW is within the certain period of time T1, the mobile telephone 40 maintains the OFF state. Thus, when the passed time is within the certain period of time T1, the microcomputer 15 can control the mobile telephone 40 to inhibit to rewrite data from the SRAM 43a to the nonvolatile memory 43b. Therefore, data rewriting from the SRAM 43a to the nonvolatile memory 43b in connection with the repetition of ON/OFF of the ACC switch can be prevented.

Here, it is determined that data can be written in the non-volatile memory 43b for a certain number of times or below. Conventionally, data is rewritten from the SRAM 43a to the nonvolatile memory 43b in connection with the repetition of ON/OFF of the ACC switch. On the other hand, according to this embodiment, data can be prevented from being rewritten from the SRAM 43a to the nonvolatile memory 43b. Thus, the number of times of rewriting data in the nonvolatile memory 43b can be reduced, which can increase the life of the nonvolatile memory 43b.

(Second Embodiment)

In the second embodiment, a mobile telephone 40A is constructed to be able to maintain the power supply state for a certain period of time T1 irrespective of the electronic control unit 10 after the state shift of the ACC switch SW.

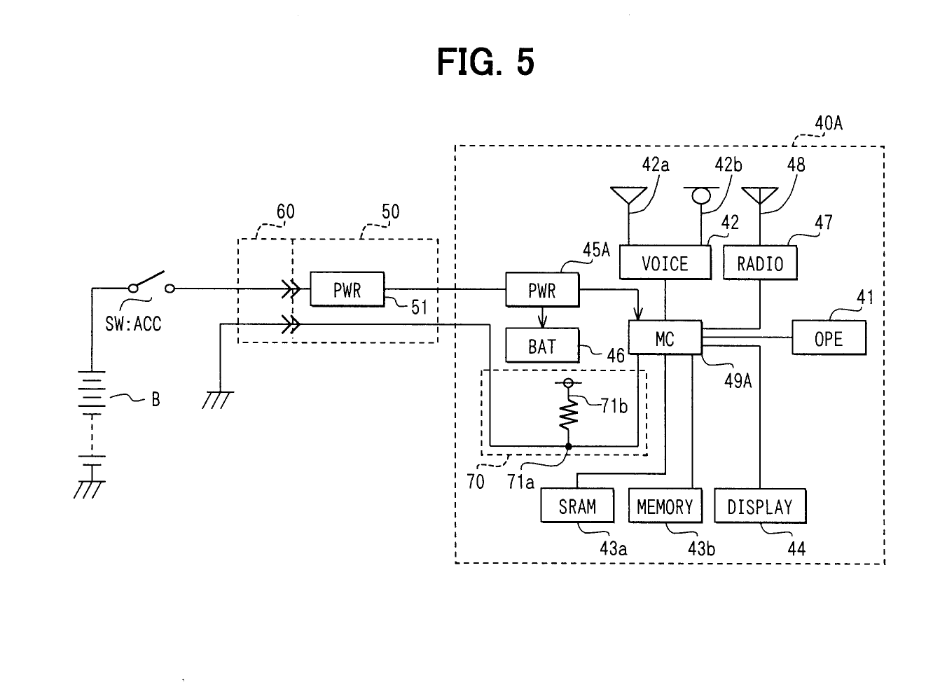

In FIG. 5, a car-mounted mobile telephone system according to the second embodiment has a mobile telephone 40A and a charge connector 50. The charge connector 50 has a power supply circuit 51. Here, when the charge connector 50 is connected to a vehicle power supply connector (power supply connector for a cigarette lighter) 60, the positive terminal of a battery B is connected to the power supply circuit 51 through an ACC switch SW.

Thus, the power supply circuit 51 steps down the positive voltage of the battery B and outputs a high-level signal when the ACC switch SW is ON (closed state). On the other hand, when the ACC switch SW is OFF (open state), the power supply circuit 51 outputs a low-level signal.

Furthermore, the mobile telephone 40A includes an operating unit 41, a voice processing circuit 42, a speaker 42a, a microphone 42b, a nonvolatile memory 43b, an SRAM 43a, a display 44, a power supply circuit 45A, a secondary battery 46, a radio unit 47, an antenna 48, a microcomputer 49A and a pull-up resistor 70.

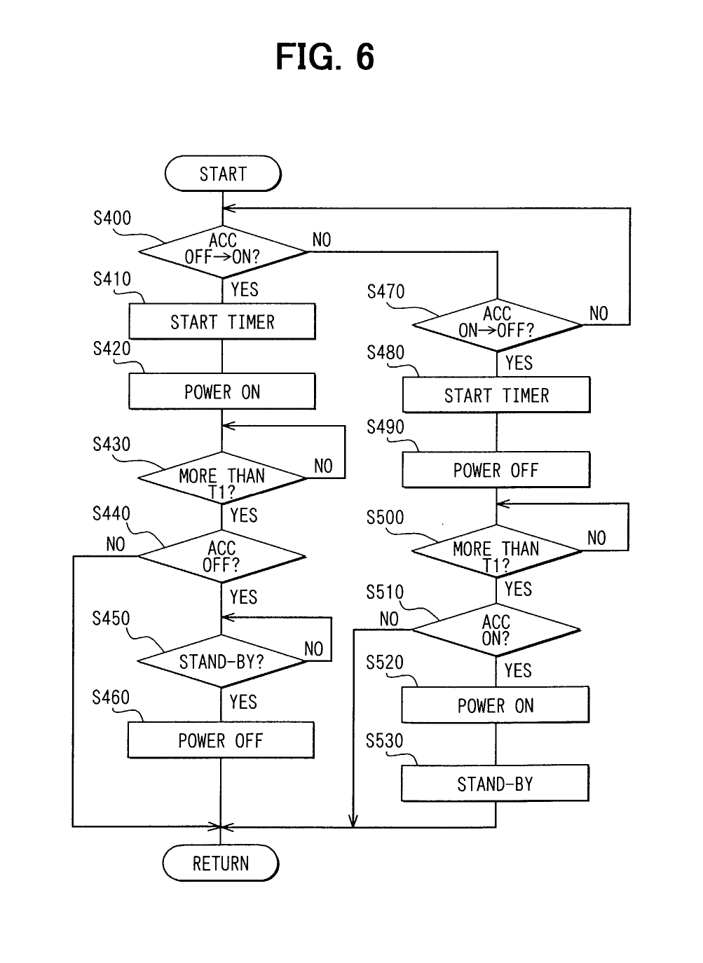

The power supply circuit 45 steps down the high-level signal from the power supply circuit 51 and charges stepped-down output into the secondary battery 46. The power supply circuit 45A receives the high-level signal from the power supply circuit 51 and outputs the high-level output signal to the microcomputer 49A. On the other hand, the power supply circuit 45A receives the low-level signal from the power supply circuit 51 and outputs the low-level output signal to the microcomputer 49A. The microcomputer 49A performs the power supply processing in accordance with steps in the flowchart shown in FIG. 6.

One terminal 71a of the pull-up resistor 70 is connected to the microcomputer 49A. The other terminal 71b of the pull-up resistor 70 is connected to the positive terminal of the power supply circuit 45A. The pull-up resistor 70 serves to detect the connection to the vehicle power supply connector 70 in the charge connector 50.

An operation according to the second embodiment will be described below with reference to FIG. 6. FIG. 6 is a flowchart showing power supply processing by the microcomputer 49A.

First, when the charge connector 50 is disconnected from the vehicle power supply connector 60, one terminal 71a of the pull-up resistor 70 outputs the high-level signal to the microcomputer 49A. Thus, the microcomputer 49A can detect that the charge connector 50 is disconnected from the vehicle power supply connector 60.

Then, when the charge connector 50 is connected to the vehicle power supply connector 60, one terminal 71a of the pull-up resistor 70 is connected to the vehicle ground through the charge connector 50 and then through the vehicle power supply connector 60. Thus, one terminal 71a of the pull-up resistor 70 outputs the low-level signal to the microcomputer 49A. Then, the microcomputer 49A starts to execute a computer program in accordance with steps in the flowchart shown in FIG. 6.

First, at step S400, it is determined whether or not the ACC switch SW is shifted from OFF to ON. Here, when the output from the power supply circuit 45A shifts from the low level signal to the high-level signal, it is determined that the ACC switch SW undergoes the OFF-ON shift. Then, the processing proceeds to step S 410, where the built-in timer starts counting and the power supply is turned on at step S430.

Next, based on the count by the built-in timer, it is determined at step S430 whether or not the time passing from the OFF-ON shift in the ACC switch SW is within the certain period of time T1. Here, when the time passing from the OFF-ON shift is within the certain period of time T1, the processing of step S420 is repeated.

On the other hand, at step S430, when the time passing from the OFF-ON shift is equal to or more than the certain period of time T1, the processing proceeds to step S440. Here, it is determined whether or not the ACC switch SW is in the OFF state.

Here, when the output signal from the power supply circuit 45A is at the low level, it is determined that the ACC switch SW is in the OFF state. Then, the processing proceeds to step S450, where it is determined whether or not it is in stand-by mode. When it is in stand-by mode, the power supply OFF processing is performed. Here, data stored in the SRAM 43a is moved to the nonvolatile memory 43b.

Next, when it is determined that the ACC switch SW does not undergo the OFF-ON shift at step S400, that is, when the ACC switch SW is in one of the ON-OFF shift state, ON state and the OFF state, the processing proceeds to step S470.

Here, when the output signal from the power supply circuit 45A shifts from the high level to the low level, it is determined that the ACC switch under goes the ON-OFF shift. Then, the processing proceeds to step S480. Then, the built-in timer starts counting, and the power supply OFF processing is performed (S490). Thus, data stored in the SRAM 43a is moved to the nonvolatile memory 43b.

Next, based on the count by the built-in timer, it is determined whether or not the time passing from the ON-OFF shift in the ACC switch SW is within a certain period of time T1 (S500). Here, if the time passing from the ON-OFF shift is within the certain period of time T1, the processing returns to step S500. On the other hand, if the time passing from the ON-OFF shift is equal to or more than the certain period of time T1 at step S500, the processing proceeds to step S510.

Thus, it is determined whether or not the ACC switch SW is ON. When the output signal from the power supply circuit 45A is at the high level, it is determined that the ACC switch SW is ON. Then, the processing proceeds to step S520, where the power supply ON processing and then stand-by processing are performed at step S530.

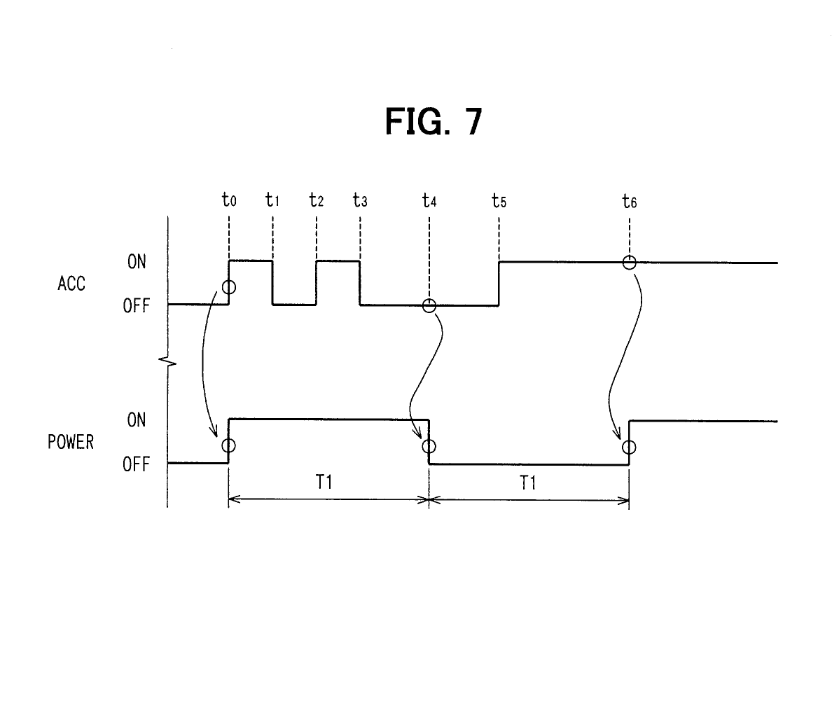

Next, a specific operation of the second embodiment will be described with reference to FIG. 7. FIG. 7 is a timing diagram showing power supply state of the ACC switch SW and the mobile telephone.

First, at timing t0, when the ACC switch SW is shifted from OFF to ON, the mobile telephone 40 shifts from the power supply OFF state to the power supply ON state.

Here, even if the state of the ACC switch SW is changed repeatedly at timing t1, t2 and t3 under the condition that the time passing from the timing t0 is within the certain period of time T1, the mobile telephone 40 maintains the power supply ON state.

Here, at timing t3, the ACC switch SW is changed to the OFF state. At timing t4 after the certain period of time T1 or longer passed from timing t0, the mobile telephone 40 enters into the power supply OFF state.

Furthermore, at timing t5 after the time shorter than the certain period of time T1 passed from timing t4, the mobile telephone 40 maintains the power supply OFF state even if the ACC switch SW shifts from OFF to ON. However, at timing t5 after the certain period of time or longer passed from the timing t4, the mobile telephone 40 shifts from the power supply OFF state to the power supply ON state.

As described above, when the microcomputer 49A of the mobile telephone 40A detects a change in the state of the ACC switch SW (S400, S470), the power supply state is shifted from one to the other between the power supply ON and OFF based on the change in the state of the ACC switch SW. Thus, when the time passing from the state change of the ACC switch SW is within the certain period of time T1, the other power supply state is maintained (S430, S500).

Thus, change in power supply state of the mobile telephone 40A due to the repetition of changes in state of the ACC switch SW can be prevented. As a result, a number of times of the changes in power supply state of the mobile telephone 40A can be reduced, which can prevents adverse influences on the mobile telephone 40A.

More specifically, during the certain period of time T1 after the state change of the ACC switch SW, data can be prevented from being rewritten from the SPAM 43a to the nonvolatile memory 43b. Thus, data rewriting from the SRAM 43a to the nonvolatile memory 43b in connection with ON/OFF of the ACC switch can be prevented. As a result, like the first embodiment, the number of times of rewriting data in the nonvolatile memory 43b can be reduced, which can increase the life of the nonvolatile memory 43b.

The embodiments are described where data rewriting from the SRAM 43a to the nonvolatile memory 43b is inhibited during the certain period of time T1 after the ON-OFF shift of the ACC switch. However, it is not limited thereto. Data output from the microcomputer 49, for example, other than SRAM 43a can be inhibited from being written in the nonvolatile memory 43b.

Furthermore, the embodiments are described where data writing into the nonvolatile memory 43b is inhibited during the certain period of time T1 after the ON-OFF shift of the ACC switch SW. However, data writing into the nonvolatile memory 43b can be inhibited during the certain period of time T1 after the OFF-ON shift of the ACC switch SW.

The present invention may be implemented by adopting a DRAM, which is fed for a certain period of time to refresh, instead of the SRAM, which is fed to store data.

In the embodiments, a mobile telephone is applied as the mobile apparatus. However, it is not limited thereto. Different kinds of mobile apparatuses may be applied such as a portable handy phone system (PHS) and a mobile information terminal.

The program for implementing the above functions may be distributed over a network, or it may be stored in a memory medium for distribution. Alternatively, the program may be downloaded by using a communication function of the mobile telephone 40 (or mobile telephone 40A) and then be installed for use.

According to the embodiments, data rewriting in the nonvolatile memory 43b is inhibited. However, it is not limited thereto. Data erasing from the nonvolatile memory 43b may be inhibited.

According to the embodiments, the power supply state of the mobile telephone is controlled based on a switch signal from the ACC switch. However, it is not limited thereto. The power supply state of the mobile telephone may be controlled based on a switch signal from the ignition switch.

What is claimed is:

1. A power supply system connectable to a mobile apparatus for controlling the mobile apparatus so as to shift from one power supply state to another power supply state between a power supply ON and a power supply OFF by outputting a power supply control signal in response to a trigger signal, the system comprising:
control means for controlling the mobile apparatus to maintain the another power supply state for a certain period of time after the power supply control signal is output.

2. A power supply system according to claim 1, wherein the mobile apparatus includes a memory for maintaining data, and the control means controls the mobile apparatus to inhibit writing and erasing of data in the memory for the certain period of time.

3. A power supply system according to claim 1, further comprising:
a microphone and a speaker for performing hands-free speech by using the mobile apparatus.

4. A power supply system according to claim 1, further comprising:
a charging line for charging the mobile apparatus.

5. A power supply system according to claim 1, wherein the trigger signal is a switch signal from an accessory switch or an ignition switch of a vehicle.

6. A mobile apparatus, which can be controlled to shift from one power supply state to another power supply state between a power supply ON and a power supply OFF based on a power supply control signal from an external apparatus, the apparatus comprising:
maintaining means for maintaining the other power supply state for a certain period of time after the power supply control signal is received.

7. A mobile apparatus according to claim 6, further comprising:
a memory (43b),
wherein the maintaining means inhibits writing or erasing of data in the memory for the certain period of time.

8. A mobile apparatus according to claim 6, wherein the external apparatus is provided with a charging line for charging the mobile apparatus itself.

9. A mobile apparatus according to claim 6, further comprising:
an operating unit for shifting from the one power supply state to the another power supply state in response to an operation by a user.

10. A program for causing a computer of a power supply control device for controlling power supply to a mobile apparatus to function as:
shift controlling means for controlling the mobile apparatus so as to shift from one power supply state to another power supply state between a power supply ON and a power supply OFF by outputting a power supply control signal in response to a trigger signal; and
maintenance control means for controlling the mobile apparatus to maintain the another power supply state for a certain period of time after the power supply control signal is output.

11. A program for causing a computer of a mobile apparatus to function as:
shift means for shifting from one power supply state to another power supply state between a power supply ON and a power supply OFF based on a power supply control signal from an external apparatus; and
maintaining means for maintaining the another power supply state for a certain period of time after the power supply control signal is received.

12. A hands-free apparatus connectable to a mobile phone for operating the mobile phone in a hands-free mode, the apparatus comprising:
a power supply system for generating a power-on signal to start an electric power supply to the mobile phone from a power OFF condition when a user-operable vehicle switch is turned on, and generating a power-off signal to stop the electric power supply to the mobile phone from a power ON condition when the vehicle switch is turned off; and
a control circuit for maintaining the power OFF condition and the power ON condition for a predetermined period after the power-on signal and the power-off signal are generated, respectively, irrespective of changes of ON/OFF conditions of the vehicle.
